(19) United States
(12) Patent Application Publication
(10) Pub. No.: US 2025/0278625 A1
(43) Pub. Date: Sep. 4, 2025

(54) VISUOMOTOR POLICY LEARNING VIA ACTION DIFFUSION

(71) Applicants: Toyota Research Institute, Inc., Los Alto, CA (US); Massachusetts Institute of Technology, Cambridge, MA (US); The Trustees of Columbia University in the City of New York, New York, NY (US)

(72) Inventors: CHENG CHI, New York, NY (US); Siyuan Feng, Somerville, MA (US); Yilun Du, Cambridge, MA (US); Zhenjia Xu, New York, NY (US); Eric A. Cousineau, Cambridge, MA (US); Benjamin Burchfiel, Somerville, MA (US); Shuran Song, New York, NY (US)

(73) Assignees: Toyota Research Institute, Inc., Los Altos, CA (US); Toyota Jidosha Kabushiki Kaisha, Toyota-shi (JP); Massachusetts Institute of Technology, Cambridge, MA (US); The Trustees of Columbia University in the City of New York, New York, NY (US)

(21) Appl. No.: 18/594,842

(22) Filed: Mar. 4, 2024

(51) Int. Cl. G06N 3/08

(52) U.S. Cl. CPC G06N 3/08

(57) ABSTRACT

A method includes receiving observation data comprising sensor data associated with a robot while one or more humans are controlling the robot to perform a specified task, receiving control data comprising control commands input by the one or more humans while controlling the robot to perform the specified task, adding Gaussian noise to the control data to generate noisy control data, and training a neural network, based on the noisy control data to receive the observation data and first Gaussian noise, and output an action sequence, comprising a plurality of action steps, to be performed by the robot to perform the specified task.

### TECHNICAL FIELD

The present specification relates to training a robot to learn to perform actions based on demonstration, and more particularly, to visuomotor policy learning via action diffusion.

### BACKGROUND

One way to train a robot to perform a particular action is via demonstration. This may be formulated as the supervised regression task of learning to map observations to actions. For example, a human may control a robot to perform the action. A system may then learn a policy for the robot to autonomously perform the action based on the human demonstration.

However, the unique nature of predicting robot actions, which can involve multimodal distributions, sequential correlation, and may require high precision, can make this task distinct and challenging as compared to other supervised learning problems. Accordingly, a need exists for improved methods of learning robot actions from demonstration.

### SUMMARY

In one embodiment, a method includes receiving observation data comprising sensor data associated with a robot while one or more humans are controlling the robot to perform a specified task; receiving control data comprising control commands input by the one or more humans while controlling the robot to perform the specified task; adding Gaussian noise to the control data to generate noisy control data; and training a neural network, based on the noisy control data, to receive the observation data and first Gaussian noise, and output an action sequence, comprising a plurality of action steps, to be performed by the robot to perform the specified task.

In another embodiment, a computing device includes a processor configured to receive observation data comprising sensor data associated with a robot while one or more humans are controlling the robot to perform a specified task; receive control data comprising control commands input by the one or more humans while controlling the robot to perform the specified task; add Gaussian noise to the control data to generate noisy control data; and train a neural network, based on the noisy control data, to receive the observation data and first Gaussian noise, and output an action sequence, comprising a plurality of action steps, to be performed by the robot to perform the specified task.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 schematically depicts a computing device for performing visuomotor policy learning via action diffusion, according to one or more embodiments shown and described herein;

FIG. 2 depicts a convolutional neural network-based model for performing visuomotor policy learning via action diffusion, according to one or more embodiments shown and described herein;

FIG. 3 depicts a transformer-based model for performing visuomotor policy learning via action diffusion, according to one or more embodiments shown and described herein;

FIG. 4A depicts an example performance of a block pushing task using the diffusion policy disclosed herein;

FIG. 4B depicts an example performance of the block pushing task using a Long Short Term Model with a Gaussian Mixture Model;

FIG. 4C depicts an example performance of the block pushing task using behavior transformers;

FIG. 4D depicts an example performance of the block pushing task using implicit behavior cloning;

FIG. 5 depicts relative success rates for the performance of two different tasks for four different models;

FIG. 6 depicts a flowchart of a method of training the computing device of FIG. 1 to perform visuomotor policy learning via action diffusion, according to one or more embodiments shown and described herein; and

FIG. 7 depicts a flowchart of a method of operating the computing device of FIG. 1 to perform visuomotor policy learning via action diffusion, according to one or more embodiments shown and described herein.

### DETAILED DESCRIPTION

The embodiments disclosed herein include methods and systems for visuomotor policy learning via action diffusion. In particular, a plurality of humans may control a robot to perform a specified task. For example, a human may utilize a controller to control the actions of a robot to perform a task. The control actions performed by the human to control the robot may be recorded. In addition, images of the robot and its environment and/or other sensor data associated with the robot may be recorded while the robot is being controlled by the human to perform the task. The images and other sensor data, along with the control actions performed by the human may be stored as training data. The robot may be controlled by a large number of humans performing the task to collect a large amount of training data. This training data may be used to train a neural network to learn a policy for the robot to autonomously perform the specified task, as disclosed herein. In particular, a neural network may be trained to receive one or more input images and/or other sensor data indicating a current state of the robot, and to output an action sequence to be performed by the robot based on the current state in order to perform the task.

In embodiments, the neural network may utilize a diffusion policy, as disclosed herein. In particular, during training, the control actions of the training data may be corrupted with Gaussian noise. The neural network may then be trained to receive the images and other sensor data as a first input, and to receive noisy control actions as a second input, and to predict an amount of noise to be removed from the noisy control actions to obtain less noisy control actions. The less noisy control actions may then be input back into the neural network to predict additional noise to be removed to obtain even less noisy control actions. This may be performed iteratively for a predetermined number of iterations until a final set of de-noised control actions is output.

As such, once the neural network is trained, it may be deployed to determine actions to be performed by a robot. That is, the robot may capture images and other sensor data about its position and environment. The captured images and sensor data may be input to the neural network along with pure Gaussian noise representing initial control actions. The neural network may then iteratively output successive control actions with some amount of noise removed until eventually a final de-noised set of control actions are output. The robot may then implement the output control actions to perform a specified task.

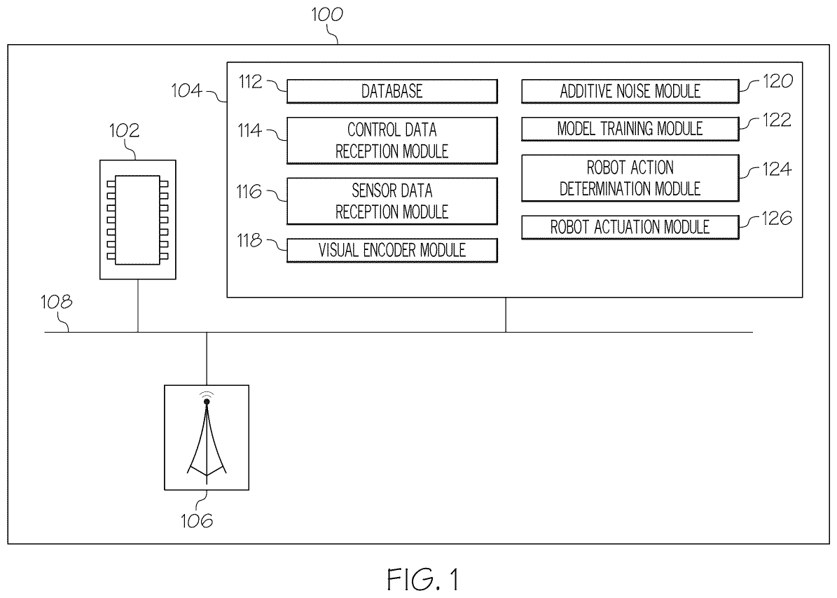

Tuning now to the figures, FIG. 1 schematically depicts a computing device 100 for learning visuomotor policy via action diffusion. In some examples, the computing device 100 may be embedded in a robot. In other examples, the computing device 100 may be a stand-alone device not embedded in a robot (e.g., a desktop computer, a server, a cloud computing device, and the like).

In the examples disclosed herein, a robot comprises a robotic arm that performs one or more actions (e.g., moving an object, pouring a liquid, and the like). However, it should be understood that in other examples, any other type of robot may be utilized. In embodiments, the computing device 100 may learn a visuomotor policy for the robot, using the techniques disclosed herein.

In the example of FIG. 1, the computing device 100 comprises one or more processors 102, one or more memory modules 104, network interface hardware 106, and a communication path 108. The one or more processors 102 may be a controller, an integrated circuit, a microchip, a computer, or any other computing device. The one or more memory modules 104 may comprise RAM, ROM, flash memories, hard drives, or any device capable of storing machine readable and executable instructions such that the machine readable and executable instructions can be accessed by the one or more processors 102.

The network interface hardware 106 can be communicatively coupled to the communication path 108 and can be any device capable of transmitting and/or receiving data via a network. Accordingly, the network interface hardware 106 can include a communication transceiver for sending and/or receiving any wired or wireless communication. For example, the network interface hardware 106 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 106 includes hardware configured to operate in accordance with the Bluetooth® wireless communication protocol. The network interface hardware 106 of the computing device 100 may transmit and receive data to and from a robot, or other computing devices, as disclosed herein.

The one or more memory modules 104 include a database 112, a control data reception module 114, a sensor data reception module 116, a visual encoder module 118, an additive noise module 120, a model training module 122, a robot action determination module 124, and a robot actuation module 126. Each of the database 112, the control data reception module 114, the sensor data reception module 116, the visual encoder module 118, the additive noise module 120, the model training module 122, the robot action determination module 124, and the robot actuation module 126 may be a program module in the form of operating systems, application program modules, and other program modules stored in the one or more memory modules 104. In some embodiments, the program module may be stored in a remote storage device that may communicate with the computing device 100. Such a program module may include, but is not limited to, routines, subroutines, programs, objects, components, data structures and the like for performing specific tasks or executing specific data types as will be described below.

The database 112 may store training data used to train a model maintained by the computing device 100. In particular, the database 112 may store data received by the control data reception module 114 and the sensor data reception module 116, as disclosed in further detail below. The database 112 may also store parameters associated with the model maintained by the computing device 100, as disclosed in further detail below. The database 112 may also store other data used by the memory modules 104.

The control data reception module 114 may receive control data comprising control commands input by humans to control a robot to perform a task. As discussed above, in embodiments disclosed herein, a robot learns to perform an action by imitating humans performing the action. Accordingly, to collect training data, humans operate a control device to control a robot to perform a task. A variety of different control devices may be used depending on the type of robot and the particular task being performed. For example, to perform a task of causing a robotic arm to move an object in a particular way, humans may operate a control device that moves the robotic arm in three dimensions to move the object. While a human is operating the control device to control the robot, the control commands input by the human may be continually recorded. These control commands may then be saved and transmitted to the computing device and received by the control data reception module 114. The control data reception module 114 may also receive a time stamp indicating when each control command was performed. This may be used to correlate control commands to sensor data, as discussed below. The control commands received by the control data reception module 114 may be saved in the database 112 as one training example.

During training, a large number of humans may control the robot to perform the task, in order to generate a large amount of training data. The control commands may be used along with the sensor data received by the sensor data reception module 116 to train the computing device 100 to learn a policy for the robot to perform the task, as disclosed in further detail below.

The sensor data reception module 116 may receive sensor data captured by a robot, as disclosed herein. As discussed above, the computing device 100 learns a policy for actions to be performed by a robot to complete a specified task. In particular, the policy may identify particular actions to be taken based on a current state of the robot and the robot's environment. As such, during deployment, the robot may capture one or more images and/or other sensor data, such that the policy can be used to determine the appropriate action for the robot to take at any given time step. Furthermore, during training, the robot may similarly capture images and/or other sensor data to be used in conjunction with the control data discussed above to train the computing device 100 to learn the policy. The sensor data reception module 116 may receive sensor data during training and during operation of a robot, as disclosed herein.

During training, as discussed above, humans may use a control device to control a robot to perform a specified task. While this is occurring, the robot may capture images and/or other sensor data. In embodiments, the robot may capture one or more images of the surrounding environment of the robot. For example, if the specified task is for the robot to move a block on a table into a particular position and/or orientation, the robot may capture an image of the block and/or the table or other surface that the block is on. In some examples, the robot may capture a single image, while in other examples, the robot may capture multiple images (e.g., from multiple viewing angles or perspectives).

In addition to image data, in some examples, the robot may capture other sensor data. For example, the robot may capture data from a proximity sensor, a load sensor, an infrared sensor, sensors that indicate an orientation or pose of the robot, and the like. In the illustrated example, the image and sensor data is captured by equipment affixed to or integrated with the robot. However, in other examples, one or more other devices not connected to the robot may collect image or other sensor data.

When a human controls a robot to perform a task during training, the robot may continually capture images and/or sensor data, which may be stored as training data. Time stamps when the various images and/or sensor data are captured may also be stored, such that they can be correlated with the control data described above. When a task is completed, the images and/or sensor data associated with the performance of the task may be transmitted to the computing device 100, and may be received by the sensor data reception module 116. The received data may be stored in the database 112 as training data. The control data received by the control data reception module 114 and the images and sensor data received by the sensor data reception module 116 may be utilized to train the model maintained by the computing device 100, as disclosed in further detail below.

After the model is trained and a policy is learned by the computing device 100, the model may be deployed to control the actions of the robot. In particular, during deployment, the robot may continually capture images and sensor data in real-time (e.g., 10 times per second). The captured data may be transmitted to the computing device 100 and received by the sensor data reception module 116. The received data may be input into the trained model, to determine real-time actions for the robot to take to perform the specified task, as disclosed in further detail below.

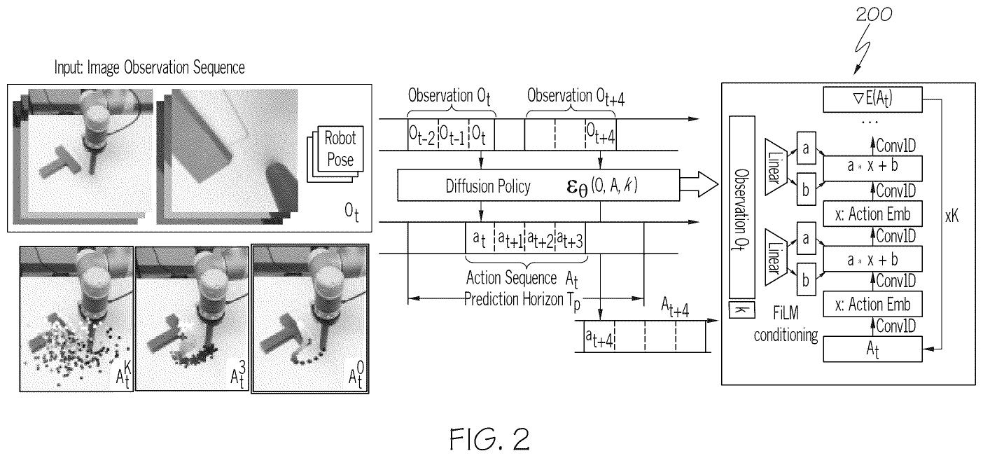

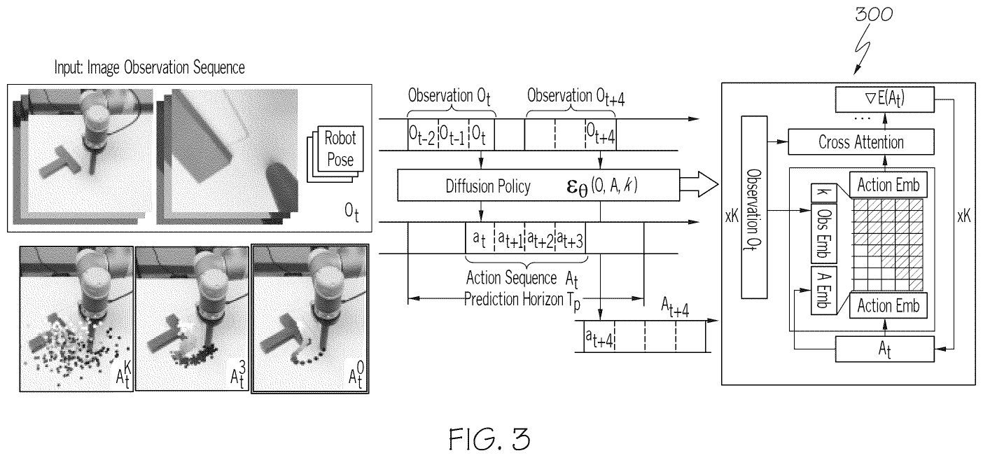

In embodiments, the model maintained by the computing device 100 is implemented by a neural network. In one example, the model may comprise a convolutional neural network (CNN)-based architecture. In another example, the model may comprise a transformer-based architecture. An example CNN-based architecture is shown in FIG. 2, and an example transformer-based architecture is shown in FIG. 3.

Turning now to FIG. 2, an example CNN-based architecture for the model maintained by the computing device 100 is shown. The example of FIG. 2 includes a CNN 200. During deployment, the CNN 200 takes observation data as input, and outputs an action sequence to be performed by the robot. In particular, at a time step t, the CNN 200 may receive the latest Tₒ steps observation data Oₜ as input and may output Tₐ steps of an action sequence Aₜ.

For each time step t, the observation data Oₜ may comprise images and/or other sensor data received by the sensor data reception module 116, as described above. In the example of FIG. 2, the latest three time steps of observation data, Oₜ₋₂, Oₜ₋₁, and Oₜ are input to the CNN 200. However, in other examples, other sequence lengths of observation data may be input to the CNN 200.

For each time step t, the action sequence Aₜ may comprise actions to be performed by the robot at one or more time subsequent time steps. In the example of FIG. 2, the CNN 200 outputs an action sequence Aₜ comprising four action steps at, aₜ₊₁, aₜ₊₂, and aₜ₊₃. However, in other examples, the action sequence Aₜ may comprise an action sequence of a different length. In some examples, the robot may perform the actions of the entire action sequence Aₜ before a new action sequence is determined based on updated observation data. However, in other examples, the robot may only perform a portion of the action in the action sequence Aₜ before a new action sequence is determined based on updated observation data. In embodiments, it has been shown that predicting an action sequence Aₜ comprising multiple action steps produces better results than predicting a single action step, even if not all of the action steps of the action sequence Aₜ are performed before a new action sequence is determined based on updated observation data. Additional details of the CNN 200 are discussed below.

FIG. 3 shows an example transformer-based architecture for the model maintained by the computing device 100 is shown. The example of FIG. 3 is similar to the example of FIG. 2 except that the CNN 200 is replaced by a transformer 300. Additional details of the transformer 300 are disclosed below.

Referring back to FIG. 1, the visual encoder module 118 may encode the images and/or sensor data received by the sensor data reception module 116. The encoded images may then be input into the model maintained by the computing device 100 (e.g., the CNN 200 or the transformer 300). In particular, the visual encoder module 118 may map a raw image sequence into a latent embedding Oₜ and is trained end-to-end with the diffusion policy. In examples where multiple images are captured from multiple camera views, each camera view uses a separate encoder, and images at each time step are encoded independently and then concatenated to form Oₜ. In the illustrated example, the visual encoder module 118 uses a standard ResNet-18, without pre-training, as the encoder with the global average pooling replaced with a spatial softmax pooling to maintain spatial information, and BatchNorm replaced with GroupNorm for stable training. This works well when the normalization layer is used in conjunction with exponential moving average. However, in other examples, other visual encoding methods may be used.

Referring still to FIG. 1, the additive noise module 120 may add noise to the control data received by the control data reception module 114, as disclosed herein. As discussed above, the control data reception module 114 may receive control commands performed by humans while controlling a robot to perform a specified task. These control commands may then be used as training data to train the model maintained by the computing device 100. In particular, Gaussian noise may be added to the control commands, and the model may be trained to remove noise to obtain the original de-noised control commands.

In embodiments, the additive noise module 120 may add noise in a series of K steps. That is, the additive noise module 120 may begin with the original control commands received by the control data reception module 114, and may add a small amount of Gaussian noise to generate first noisy control commands as step k=1. The control data reception module 114 may then add an additional amount of Gaussian noise to the first noisy control commands to generate second noisy control commands as step k=2. The additive noise module 120 may continue to add additional Gaussian noise at each subsequent step until step k=K. The noisy control commands generated at each step may be used to train the model maintained by the computing device 100, as disclosed in further detail below.

The amount of noise added at each step may be determined by a noise schedule. In particular, an amount of Gaussian noise ε^{k} may be added at each step k. The noise schedule may be determine by parameters σ, α, and γ, as discussed further below. The noise schedule may control the extent to which diffusion policy captures high and low-frequency characteristics of action signals. In the illustrated example, a Square Cosine Schedule, as discussed in Alexander Quinn Nichol and Prafulla Dhariwal, ‘Improved denoising diffusion probabilistic models’ in International Conference on Machine Learning, pgs. 8162-8171. PMLR, 2021. However, in other examples, other noise schedules may be utilized, such as a linear schedule.

Referring still to FIG. 1, the model training module 122 may train the model maintained by the computing device 100 (e.g., the CNN 200 or the transformer 300) as disclosed herein. In embodiments, visuomotor robot policy is formulated as a Denoising Diffusion Probabilistic Model (DDPM). DDPMs are a class of generative model where the output generation is modeled as a denoising process, often called Stochastic Langevin Dynamics. Diffusion policies are able to express complex multimodal action distributions and possess stable training behavior, while requiring little task-specific hyperparameter tuning.

In general, starting from x^{K} sampled from Gaussian noise, a DDPM performs K iterations of denoising to produce a series of intermediate actions with decreasing levels of noise x^{k}, x^{k-1}, . . . x⁰, until a desired noise-free output x⁰ is formed. The process follows the equation:

$${x}^{k - 1} = α ( {x}^{k} - γ {ε}_{θ} ( {x}^{k} , k ) + 𝒩 ( 0 , {σ}^{2} I ) ) ,$$

where ε_{θ} is the noise prediction network with parameter θ that is optimized through learning, and [symbol] (0, σ²I) is Gaussian noise added at each step.

The above equation may also be interpreted as a single noisy gradient descent step:

$${x}^{′} = x - γ ∇ E ( x ) ,$$

where the noise prediction network ε_{θ}(x, k) effectively predicts the gradient field ∇E(x), and γ is the learning rate. The parameters α, γ, and σ define the noise schedule, as discussed above. These parameters may be interpreted as learning rate scheduling in gradient descent process. An α of slightly less than 1 has been shown to improve stability.

To train a DDPM, unmodified examples x⁰ may be randomly drawn from the training dataset. For each sample, a denoising iteration k may be randomly selected, and then a random noise ε^{k} may be sampled with appropriate variance for iteration k. The noise prediction network is asked to predict the noise from the data sample with noise added. In particular, the noise prediction network may minimize the following loss function:

$$ℒ = M S E ( {ε}^{k} , {ε}_{θ} ( {x}^{0} + {ε}^{k} , k ) ) .$$

Minimizing the above loss function also minimizes the variational lower bound of the KL-divergence between the data distribution p(x⁰) and the distribution of samples drawn from the DDPM q(x⁰).

While DDPMs are typically used for image generation, where x is an image, in embodiment disclosed herein, a DDPM is used to learn robot visuomotor policies. As such, the output x represents robot actions rather than an image, and the denoising process is conditioned on input observation Oₜ.

An effective action formulation should encourage temporal consistency and smoothness in long-horizon planning while allowing prompt reactions to unexpected observations. To accomplish this goal, in embodiments disclosed herein, an action-sequence prediction produced by a diffusion model is integrated with receding horizon control to achieve robust action execution. In particular, at time step t, the model receives the latest Tₒ steps of observation data Oₜ and predicts Tₚ steps of actions, of which Tₐ steps of actions are executed by the robot without re-planning. Here, Tₒ is defined as the observation horizon, Tₚ is defined as the action prediction horizon, and Tₐ is defined as the action execution horizon.

As discussed above, the computing device 100 may receive images and other sensor data, which may comprise observation data Oₜ. In embodiments, a DDPM is used to approximate a conditional distribution p(Aₜ|Oₜ). That is, a robot action is predicted for given observation data. This formulation allows the model to predict actions conditioned on observations without the cost of inferring future states, thereby speeding up the diffusion process and improving the accuracy of generated actions. To capture, the conditional distribution p(Aₜ|Oₜ), the following equation may be used to for a de-noising step:

$${A}_{t}^{k - 1} = α ( {A}_{t}^{k} - γ {ε}_{θ} ( {O}_{t} , {A}_{t}^{k} , k ) + 𝒩 ( 0 , {σ}^{2} I ) ) .$$

The model training module 122 may be trained to minimize the following loss function:

$$ℒ = M S E ( {ε}^{k} , {ε}_{θ} ( {O}_{t} , {A}_{t}^{0} + {ε}^{k} , k ) ) .$$

The exclusion of observation features Oₜ from the output of the denoising process significantly improves inference speed and better accommodates real-time control. It also helps to make end-to-end training of the vision encoder feasible. The model training module 122 may operate slightly differently in the example of FIG. 2, where a CNN is used, and the example of FIG. 3, where a transformer is used, as disclosed herein.

In the example of FIG. 2, the CNN 200 receives two inputs, the observation data Oₜ and an action sequence Aₜ. In the example of FIG. 2, the conditional distribution p(Aₜ|Oₜ) is modeled by conditioning the action generation process on observation data Oₜ with Feature-wise Linear Modulation (FiLM) as well as denoising iteration k. FiLM condition of the observation data Oₜ is applied to every convolution layer, channel-wise. Initially, the action sequence Aₜ^{K} comprising pure Gaussian noise is input to the CNN 200. The action sequence is encoded into an action embedding x and is convolved with the Observation data Oₜ in one or more 1-dimensional convolutional layers to determine ∇E, which indicates a predicted amount of noise added from to action sequence Aₜ^{K-1} to arrive at Aₜ^{K}.

After the CNN 200 determines ∇E, this amount of noise is subtracted from the action sequence Aₜ^{K} to determine action sequence Aₜ^{K-1}, which is then input back into the CNN 200 during the next iteration. This process is repeated in the next iteration to determine a new value of ∇E, which is subtracted from the action sequence Aₜ^{K-1} to determine action sequence Aₜ^{K-2}. This process is repeated K times until the CNN 200 outputs action sequence Aₜ⁰, which is the de-noised action sequence based on the observation data Oₜ.

During training, the model training module 122 updates the parameters of the CNN 200 to minimize the loss function described above based on the noisy control commands determined by the additive noise module 120, as discussed above. After the CNN 200 is trained, it may be deployed to determine an action sequence to be performed by the robot to perform a specified task, as discussed in further detail below.

In the example of FIG. 3, a time-series diffusion transformer 300 is utilized instead of the CNN 200 of FIG. 2. In the example of FIG. 3, actions with noise T_{y}^{k} are passed in as input tokens for the transformer decoder blocks, with the sinusoidal embedding for diffusion iteration k prepended as the first token. The observation data Oₜ is transformed into an observation embedding sequence by a shared multilayer perceptron (MLP), which is then passed into the transformer decoder stack as input features. The gradient ε_{θ}(Oₜ, Aₜ^{k}, k) is predicted by each corresponding output token of the decoder stack. The embedding of observation data Oₜ is passed into a multi-head cross-attention layer of each transformer decoder block. Each action embedding is constrained to only attend to itself and previous action embeddings using an attention mask.

In operation, the transformer 300 operates similarly to the CNN 200. The transformer 300 receives observation data Oₜ and an action sequence Aₜ as input. The transformer 300 determines an amount of noise ∇E to be removed from the action sequence Aₜ during the next iteration. The transformer 300 performs K iterations beginning with Gaussian noise Aₜ^{K} until ending up with a de-noised action sequence Tₜ⁰. During training, the model training module 122 updates the parameters of the transformer 300 based on the noisy control commands determined by the additive noise module 120, as discussed above. After the transformer 300 is trained, it may be deployed to determine an action sequence to be performed by the robot to perform a specified task, as discussed in further detail below.

Referring back to FIG. 1, the robot action determination module 124 may use the trained model (e.g., the CNN 200 or the transformer 300) to determine a robot action to be performed by the robot based on sensor data received by the sensor data reception module 116. In particular, at a particular time step, the images and/or other sensor data received by the sensor data reception module 116 may be concatenated to determine observation data Oₜ. The observation data Oₜ and an action sequence representing Gaussian noise Aₜ^{K} may be input into the trained model. The model may output an amount of noise ∇E to be removed from Aₜ^{K} during a subsequent iteration. K iterations may be performed until the model outputs a de-noised action sequence Aₜ⁰, which may represent an action sequence to be performed by the robot beginning at time step t.

Referring still to FIG. 1, the robot actuation module 126 may implement the action sequence Aₜ⁰ determined by the trained model. In particular, the robot actuation module 126 may cause the robot to perform one or more actions of the action sequence Aₜ⁰. As described above, the action sequence Aₜ⁰ may comprise Tₚ steps of action, over the action prediction horizon, and the robot actuation module 126 may cause the robot to perform the first Tₐ steps of action, over the action execution horizon. After the action execution horizon is met and the first Tₐ steps of action are performed, the robot action determination module 124 may determine a new action sequence to be performed. In embodiments, the action prediction horizon and the action execution horizon may have any number of steps.

The diffusion policy disclosed herein may have many advantages over other approaches to determining robot actions. One such advantage may be the ability to express multimodal distributions naturally and precisely.

Multi-modality in action generation for diffusion policy arises from two sources, an underlying stochastic sampling procedure and a stochastic initialization. In stochastic Langevin Dynamics, an initial sample Aₜ^{K} is drawn from standard Gaussian at the beginning of each sampling process, which helps specify different possible convergence basins for the final action prediction Aₜ⁰. This action is then further stochastically optimized, with added Gaussian perturbations across a large number of iterations, which enables individual action samples to converge and move between different multi-modal action basins.

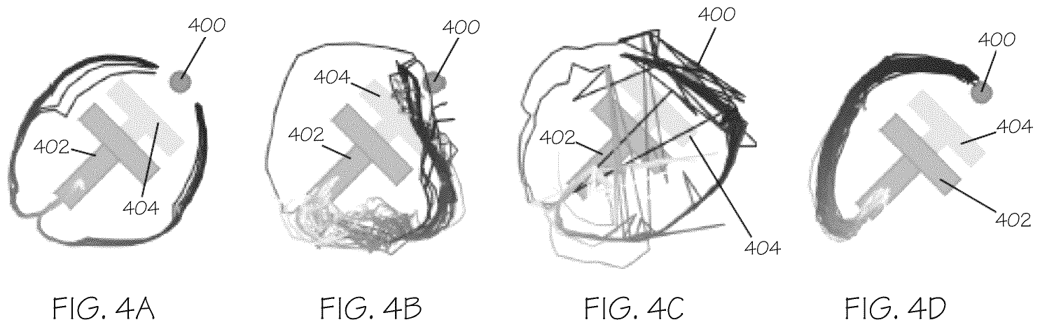

FIGS. 4A-4D show examples of different models performing the same task. In the examples of FIGS. 4A-4D, the task is for an end effector 400 to push a block 402 onto a space 404. In order to push the block 402, the end effector 400 must first move around the block 402 by either moving left or right. In the example of FIG. 4A, the disclosed diffusion policy is used, which can learn both modes and commits to only one mode within each rollout. In the example of FIG. 4B, a Long Short Term Memory (LSTM) model is used with a Gaussian Mixture Model (GMM), and is biased toward one mode. In the example of FIG. 4C, behavior transformers are used, which fail to commit to a single mode due to a lack of temporal action consistency. In the example of FIG. 4D, implicit behavior cloning is used, and is biased toward one mode.

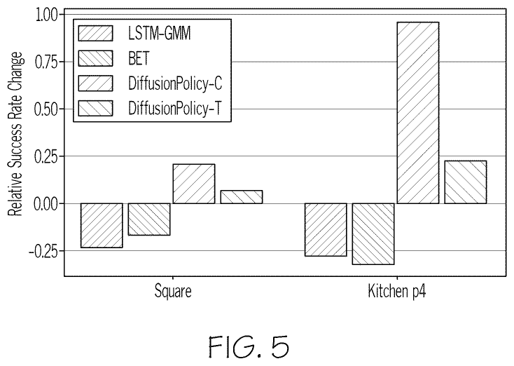

Turning now to FIG. 5, relative success rates are shown for the performance of two different tasks (square and kitchen p4) for four different models, LSTM-GMM, BET, diffusion policy with a position-control action space, and diffusion policy with velocity control. As shown in FIG. 5, diffusion policy with a position-control action space consistently outperforms diffusion policy with velocity control. It is believed that this occurs for two reasons. First, action multi-modality is more pronounced in position-control mode than when using velocity control. Because diffusion policy better expresses action multi-modality than existing approaches, it is believed that it is inherently less affected by this drawback than existing models. Furthermore, position control suffers less than velocity control from compounding error effects and is thus more suitable for action-sequence prediction. As a result, diffusion policy is both less affected by the primary drawbacks of position control and is better able to exploit the advantages of position control.

Sequence prediction is often avoided in existing policy learning methods due to the difficulties in effectively sampling from high-dimensional output spaces. However, DDPM scales well without output dimensions without sacrificing the expressiveness of the model, as demonstrated in many image generation applications. Leveraging this capability, diffusion policy represents action in the form of a high-dimensional action sequence, which naturally addresses several issues.

One such advantage is temporal action consistency. For example, as discussed above with respect to FIG. 4, the end effector 400 can go around the block 402 from either the left or the right. However, if each action in the sequence is predicted as independent multi-modal distributions, as is done in several existing methods, consecutive actions could be drawn from different modes, resulting in jittery actions that alternate between the two valid trajectories.

Another advantage is robustness to idle actions. Idle actions occur when a demonstration is paused and results in sequences of identical positional actions or near-zero velocity actions. It is common during teleoperation and is sometimes required for tasks such as pouring liquid. However, single-step policies can easily overfit to this pausing behavior.

Another advantage is that diffusion policy is more stable to train than other models such as an Energy-Based Model (EBM). An implicit policy may represent an action distribution using an EBM as shown below:

$${p}_{θ} ( a \vert o ) = \frac{{e}^{- {E}_{θ} ( o , a )}}{Z ( o , θ )} ,$$

where Z(o, θ) is an intractable normalization constant with respect to a.

To train the EBM for implicit policy, an InfoNCE-style loss function is used, as shown below, which equates to the negative log-likelihood in the above equation:

$${ℒ}_{infoNCE} = - log ( \frac{{e}^{- {E}_{θ} ( o , a )}}{{e}^{- {E}_{θ} ( o , a )} + {\sum }_{j = 1}^{{N}_{neg}} {e}^{- {E}_{θ} ( o , {ã}^{j} )}} ) ,$$

where a set of negative samples {ã^{j}}ⱼ₌₁^{N}^{_{neg}} are used to estimate the intractable normalization constant Z(a, θ). In practice, the inaccuracy of negative sampling is known to cause training instability for EBMS

Diffusion policy and DDPMs sidestep the issue of estimation Z(a, θ) altogether by modeling the score function of the same action distribution:

$${∇}_{a} log p ( a \vert o ) = - {∇}_{a} {E}_{θ} ( a , o ) - {∇}_{a} log Z ( o , θ ) \approx - {ε}_{θ} ( a , o ) ,$$

where the noise-prediction network ε_{θ}(a, o) is approximating the negative of the score function ∇ₐ log p(a|o), which is independent of the normalization constant Z(o, θ). As a result, neither the inference nor training process of diffusion policy involves evaluating Z(o, θ), thus making diffusion policy training more stable.

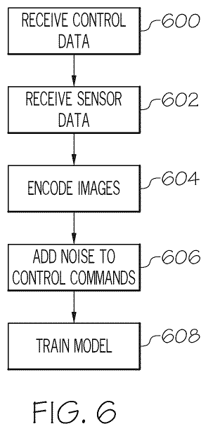

Turning now to FIG. 6, a flowchart of an example method for training the model maintained by the computing device 100 is shown. At step 600, the control data reception module 114 receives control data input by humans while controlling a robot to perform a specified task. In particular, as discussed above, humans may be instructed to control a robot to perform a task. The control commands input by the humans while controlling the robot may be received by the control data reception module 114.

At step 602, the sensor data reception module 116 receives images and/or other sensor data captured while humans are controlling the robot to perform the specified task. As discussed above, while humans are controlling the robot to perform the task, the robot and/or other devices may capture images and/or other sensor data. For example, the robot may capture images of portions of the robot or the environment of the task being formed. The robot may also capture sensor data, such as a pose or orientation of the robot. The control data received by the control data reception module 114 and the images and/or sensor data received by the sensor data reception module 116 may be used as training data to train the model maintained by the model maintained by the computing device 100.

At step 604, the visual encoder module 118 encodes the images received by the sensor data reception module 116. In particular, the visual encoder module 118 may encode the images such that they may be input to the model maintained by the computing device 100.

At step 606, the additive noise module 120 adds noise to the control commands received by the control data reception module 114, as discussed above. In particular, the additive noise module 120 may add Gaussian noise in a series of K steps to generate noisy control commands. The noisy control commands may be used to train the model maintained by the computing device 100, as discussed above.

At step 608, the model training module 122 trains the model maintained by the computing device 100. In particular, the model training module 122 may train the model to receive images and/or sensor data associated with a robot, and output an action sequence for the robot to perform a specified action. The model training module 122 may train the model comprising the CNN 200 of FIG. 2 or the transformer 300 of FIG. 3, as discussed above.

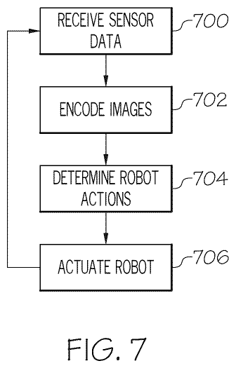

Turning now to FIG. 7, a flowchart of an example method for operating the model maintained by the computing device 100, during deployment, after the model has been trained is shown. At step 702, the sensor data reception module 116 receives images and/or other sensor data captured by a robot while performing a specified task. As discussed above, the robot may capture images of portions of the robot or the environment of the task being formed, and sensor data, such as a pose or orientation of the robot.

At step 702, the visual encoder module 118 encodes the images received by the sensor data reception module 116. In particular, the visual encoder module 118 may encode the images such that they may be input to the trained model.

At step 704, the robot action determination module 124 determines actions to be performed by the robot. In particular, the robot action determination module 124 inputs the encoded images and/or other sensor data into the CNN 200 or the transformer 300, as described above. The CNN 200 or the transformer 300 then outputs a robot action sequence, using the techniques described above.

At step 706, the robot actuation module 126 causes the robot to perform one or more steps of the action sequence determined by the robot action determination module 124. Control then returns to step 700 and additional observation data is received by the sensor data reception module 116. Accordingly, observation data is continually received by the computing device 100, and updated actions are continually determined and performed by the robot to perform the specified task.

It should now be understood that embodiments described herein are directed to visuomotor policy learning via action diffusion. In particular, diffusion policy, as disclosed herein, may be used to determine actions for a robot to perform a specified task. The diffusion policy disclosed herein may express multimodal action distributions, may be scalable to high-dimension output spaces, and may provide for stable training.

The disclosed diffusion policy's capability to predict high-dimensional action sequences is combined with receding horizon control to achieve robust execution. This allows the policy to continuously re-plan its action in a closed-loop manner while maintaining temporal action consistency, thereby achieving a balance between long-horizon planning and responsiveness.

The disclosed diffusion policy is vision-conditioned, such that visual observations are treated as conditioning instead of a part of a joint data distribution. In this formulation, the diffusion policy extracts a visual representation once regardless of the denoising iterations, which drastically reduces the computation and enables real-time action inference.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving observation data comprising sensor data associated with a robot while one or more humans are controlling the robot to perform a specified task;
receiving control data comprising control commands input by the one or more humans while controlling the robot to perform the specified task;
adding Gaussian noise to the control data to generate noisy control data; and
training a neural network, based on the noisy control data, to receive the observation data and first Gaussian noise, and output an action sequence, comprising a plurality of action steps, to be performed by the robot to perform the specified task.

2. The method of claim 1, wherein the observation data comprises a plurality of image sequences from different viewing perspectives, the method further comprising:
mapping each image sequence into a latent embedding.

3. The method of claim 2, further comprising:
using a plurality of encoders to map each image sequence into the latent embedding using a different encoder; and
training the plurality of encoders in an end-to-end manner.

4. The method of claim 1, wherein the sensor data comprises an orientation of the robot.

5. The method of claim 1, further comprising:
adding different amounts of Gaussian noise to the control data at K steps according to a noise schedule.

6. The method of claim 5, wherein the noise schedule comprises a square cosine schedule.

7. The method of claim 5, further comprising:
training the neural network to receive the observation data and noisy control data at step k, and predict an amount of noise to be subtracted from the noisy control data at step k, to determine noisy control data at step k−1.

8. The method of claim 1, wherein the neural network comprises a convolutional neural network.

9. The method of claim 1, wherein the neural network comprises a transformer.

10. The method of claim 1, further comprising:
receiving second observation data comprising sensor data associated with the robot during deployment;
inputting the second observation data and second Gaussian noise into the neural network after it has been trained to generate a second action sequence, comprising a plurality of action steps; and
causing the robot to perform one or more action steps of the action sequence.

11. A computing device comprising a processor configured to:
receive observation data comprising sensor data associated with a robot while one or more humans are controlling the robot to perform a specified task;
receive control data comprising control commands input by the one or more humans while controlling the robot to perform the specified task;
add Gaussian noise to the control data to generate noisy control data; and
train a neural network, based on the noisy control data, to receive the observation data and first Gaussian noise, and output an action sequence, comprising a plurality of action steps, to be performed by the robot to perform the specified task.

12. The computing device of claim 11, wherein:
the observation data comprises a plurality of image sequences from different viewing perspectives; and
the processor is further configured to map each image sequence into a latent embedding.

13. The computing device of claim 12, wherein the processor is further configured to:
use a plurality of encoders to map each image sequence into the latent embedding using a different encoder; and
train the plurality of encoders in an end-to-end manner.

14. The computing device of claim 11, wherein the sensor data comprises an orientation of the robot.

15. The computing device of claim 11, wherein the processor is further configured to:
add different amounts of Gaussian noise to the control data at K steps according to a noise schedule.

16. The computing device of claim 15, wherein the noise schedule comprises a square cosine schedule.

17. The computing device of claim 16, wherein the processor is further configured to:
train the neural network to receive the observation data and noisy control data at step k, and predict an amount of noise to be subtracted from the noisy control data at step k, to determine noisy control data at step k−1.

18. The computing device of claim 11, wherein the neural network comprises a convolutional neural network.

19. The computing device of claim 11, wherein the neural network comprises a transformer.

20. The computing device of claim 11, wherein the processor is further configured to:
receive second observation data comprising sensor data associated with the robot during deployment;
input the second observation data and second Gaussian noise into the neural network after it has been trained to generate a second action sequence, comprising a plurality of action steps; and
cause the robot to perform one or more action steps of the action sequence.
